(19) United States
(12) Patent Application Publication
(10) Pub. No.: US 2007/0107748 A1
(43) Pub. Date: May 17, 2007

(54) Vacuum cavitational streaming

(76) Inventors: Donald Gray, Warwick, RI (US); Charlotte Frederick, Tempe, AZ (US)

Correspondence Address: BARLOW, JOSEPHS & HOLMES, LTD., 101 DYER STREET, 5TH FLOOR, PROVIDENCE, RI, 02903, US

(21) Appl. No.: 11/280,021

(22) Filed: Nov. 16, 2005

(51) Int. Cl. B08B 7/04; B08B 5/04; B08B 3/12

(52) U.S. Cl. 134/1; 134/21; 134/10

(57) ABSTRACT

An enhanced Vacuum Cavitational Streaming (VCS) process focuses on the formation of vapor bubbles and the transfer of a chemical from the solvent to the surface of the object while the chemical is in the vapor state within the bubble, i.e. a chemical mechanism. There is less importance on the rapid implosion (physical mechanism) of the bubble, and more focus on the controlled formation and collapse (as opposed to implosion) of the vapor bubble.

### BACKGROUND OF THE INVENTION

The instant invention relates to material treatment processes, and more particularly to a closed solvent processing system that enhances the transfer of a material to or from a liquid to or from a solid surface by producing vapor bubbles at the solid surface and either detaching or collapsing these vapor bubbles in a cyclical manner under a controlled pressure. The material is more readily transferred in a vapor state in direct contact with the solid surface rather than in a liquid state.

The transfer of material to or from a solid surface submerged within a liquid encounters most of the resistance to mass transfer within the fluid boundary layer surrounding the solid surface. It is within this region that the fluid velocity used to convectively transfer either dislodged or dissolved material away from the object into the bulk fluid (used as the cleaner or extraction fluid) is dampened and decreases rapidly as the solid surface is approached. The velocity of even very fast moving fluids generally go to zero at the surface of the object and therefore there is a region surrounding the object in which the fluid is actually flowing slower than the bulk fluid in a cleaning vessel. The boundary layer is defined as the distance from the solid surface within which the fluid velocity moves much slower than the bulk of the free stream of fluid flowing past the solid. It is within this boundary layer that the rate of mass transfer slows due to a dependence upon molecular transfer mechanisms as opposed to the more rapid eddy transfer mechanism encountered in bulk fluids.

Increasing the fluid velocity reduces the boundary layer thickness and thus enhances the transfer rate, however, the boundary layer can never be totally eliminated. Similarly, megasonic processes reduce the boundary layer size with increased frequency, however megasonic bubbles always form within the bulk liquid and thus a fluid boundary layer always exists.

The transfer of insoluble material from a surface is a special consideration when considering the boundary layer thickness. As opposed to the dissolution and transfer of soluble substances, insoluble material must first be detached from the surface prior to moving into the bulk fluid. Therefore an energy threshold needs to be reached in order to transfer any material at all. If the boundary layer is large as compared to the particle of insoluble material, then the particle may never see this energy threshold and no solid removal will be accomplished. Increasing the frequency of megasonics does move the bubbles formed in the liquid closer to the solid surface thus reducing the boundary layer thickness but the higher frequency forms smaller bubbles that release less energy. Typically higher energy inputs are required to compensate for the lower energy imploding bubbles that often leads to damage to the solid surface being treated.

### SUMMARY OF THE INVENTION

Vacuum Cavitational Streaming (VCS) is a new technology presently being used to enhance the transfer of material to or from the surface of a solid. The process is accomplished by reducing the total pressure in a controlled environmental chamber containing a part submerged in a liquid to below the vapor pressure of the liquid. The process results in the formation of vapor bubbles at the solid part's surface where typically nucleation sites for bubble formation can be found in the form of imperfections, crevices or foreign particle material. The return of the chamber to pressures at or above the liquid vapor pressure collapses these vapor bubbles releasing energy at the solid surface. The energy disrupts the fluid boundary layer near the solid surface and enhances the removal of material from the surface or continuously replenishes the liquid within the boundary layer to produce a high concentration of material being transferred to the surface. Since the turbulent disruption begins at the solid surface, the process is unaffected by the size of the fluid boundary layer, a major resistance region for conventional forced convective mass transfer or ultrasonic processes.

It is worthy at this early point of discussion to note several key differences in the present invention in contrast to known prior art processes. We cite, for example, the decompression processing system in the Applicant's previously issued U.S. Pat. No. 6,418,942, wherein the key feature of that invention was the repeated, rapid cycling of vacuum and pressure to rapidly form and implode vapor bubbles on the surface of an object. We emphasize here the importance of imploding the bubbles as the primary “physical” mechanism for treatment in the '942 patent. In the '942 patent, the preferred embodiment was a cleaning system using a percloroethylene solvent to clean greasy parts. The system was rapidly cycled to generate percloroethylene vapor bubbles and then implode these bubbles. The implosion of the bubbles, locally formed at or around grease particles on the part surface, imparts energy to the surface and particle and causes the particle(s) to detach from the surface and be released into the liquid solvent, i.e. cleaned. The prior art systems focused on the implosion of the bubble for energy and carrying away the particle in the liquid solvent.

The present invention focuses on the formation of vapor bubbles and the transfer of a chemical to the surface of the object while the chemical is in the vapor state within the bubble, i.e. a chemical mechanism. There is less importance on the rapid implosion (physical mechanism) of the bubble, and more focus on the controlled formation and collapse (as opposed to implosion) of the vapor bubble.

The operating pressure of the current VCS process are orders of magnitude lower than that encountered in megasonic systems resulting in less damage to the surface of the solid part and the control of the pressurizing step can control the magnitude of the energy released by the imploding bubbles. It may be desirable however to dampen or eliminate the imploding bubbles by using soluble gases in the process along with the soluble vapor bubbles formed.

The diffusion rate of compounds in a gas or vapor phase mixture is orders of magnitude greater than the same compound mixture in a liquid state. When dealing with the transfer of material from a vapor or gas bubble into a surrounding liquid, the resistance to mass transfer in the gas bubble is always considered negligible and the rate of transfer can be attributed to the liquid phase mass transfer resistance only. Similarly, the rate of heat transfer is significantly increased during boiling heat transfer.

It would be expected that the rate of mass transfer to a surface would also be enhanced if the material being transferred were first transferred into a vapor state that comes directly in contact with the surface. This is what occurs when boiling a liquid on a surface. The main objective of this invention is to enhance the transfer of material to or from a liquid to a solid surface by producing vapor bubbles at the surface and either detaching or collapsing these bubbles in a cyclical manner under a controlled pressure. In general the new process is an enhanced vacuum cavitational streaming (VCS) process, which generates a vapor bubble often with a non-condensable gas that may or may not be collapsed.

A method of treating an object in an enclosed solvent vacuum cavitational processing system, including a solvent supply system in sealable communication with a processing chamber comprises the steps of:

(a) sealing the solvent supply system with respect to the chamber;

(b) opening the chamber to atmosphere and placing an object to be treated in the chamber;

(c) evacuating the chamber to remove air and other non-condensable gases;

(d) sealing the chamber with respect to atmosphere;

(e) opening the chamber with respect to the solvent supply system and introducing a solvent into the evacuated chamber;

(f) processing the object by pulling vacuum in the chamber to produce vapor bubbles at the surface of the object;

(g) recovering the solvent introduced into the chamber;

(h) recovering the solvent from the vacuum chamber exiting stream

(i) sealing the chamber with respect to the solvent supply system;

(j) introducing a gas into the chamber for sweeping further solvent on the object and within the chamber;

(k) recovering the gases introduced into the chamber; and

(l) opening the chamber and removing the treated object.

The above-noted method can be effectively used to provide a controlled transfer rate of material to a surface by controlling the vapor formation at the surface. Since diffusion is a 100 fold faster in a vapor state as compared to liquid diffusion, the transfer rate is directly controlled by controlling the size and frequency of the formation of the vapor bubbles at the surface. Varying the rate and magnitude of the pressure fluctuations in the VCS process accomplishes this.

Another aspect of this invention is to dampen the implosion step (if used) in the VCS process by either adding or forming a non-condensable gas to a growing vapor bubble. Non-condensable gas will slow the collapse of a vapor bubble thus dampening the energy released. This is often desirable in order to prevent damage to intricate parts.

It has also been found that it is possible to enhance the growth of vapor bubbles formed in a VCS process by adding heat in the form of liquid, vapor or gas streaming passed the solid surface or targeting the surface with energy from sources such as lasers or UV light or microwaves. In the process as described, wherein

Still another aspect of this invention is to control the rate of reactions of chemicals with a surface by rapidly increasing the reactant in the liquid state by vaporizing the chemical reactant to the vapor state. By controlling the vapor rate formation at the surface, the rate of reaction is also controlled.

The present invention also provides a means of recovering vapor produced in the VCS process so as to prevent hazardous discharge to the environment or to recycle the solvent for additional surface treatment.

Other objects, features and advantages of the invention shall become apparent as the description thereof proceeds when considered in connection with the accompanying illustrative drawings.

### DESCRIPTION OF THE DRAWINGS

In the drawings which illustrate the best mode presently contemplated for carrying out the present invention:

FIG. 1 is a schematic illustration of the closed solvent processing system as used in the present invention;

FIG. 2 is a schematic illustration of an alternative embodiment of the closed solvent processing system showing a rotatable holder for spinning the object to be processed;

FIG. 3 is a graphical view of an equilibrium curve for ammonia-water at a typical VCS pressure level (constant pressure 200 mmHg) and varying temperature;

FIG. 4 is a graphical view of an equilibrium curve for ammonia-water at a constant temperature of 120° F. and varying pressure; and

FIG. 5 is another schematic illustration of third embodiment including a waste management system.

### DESCRIPTION OF THE PREFERRED EMBODIMENT

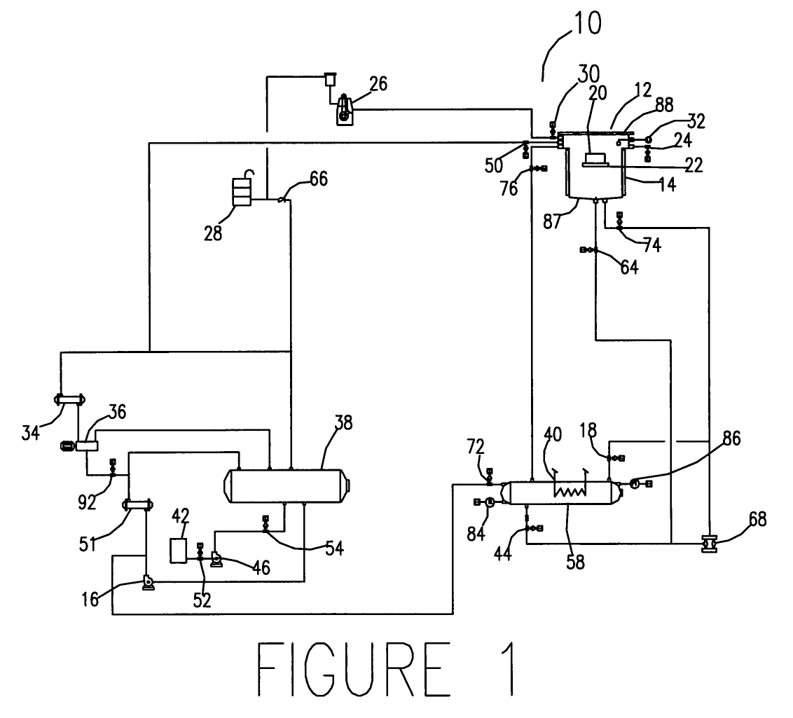

Referring now to the drawings, the solvent and aqueous decompression processing system of the present invention is illustrated and generally indicated at 10 in FIG. 1.

In FIG. 1, the system 10 for implementing the teachings of this invention includes a main vacuum cavitational streaming (VCS) chamber generally indicated at 12 that may or may not be heated. The main VCS chamber 12 includes a main body portion 87 and a lid 88. In the preferred embodiment, the main body portion 87 of the VCS chamber 12 has an electric heat blanket 14. Other options for heating the chamber 12 include steam, or other heat transfer fluids, such as oil or hot water in an external jacket, plate coils or external pipe welded or soldered to the chamber. The system 10 further includes a solvent source generally indicated at 42, a solvent holding tank generally indicated at 38, and a heated solvent vessel generally indicated at 58. Other component parts of the system 10 will be described in connection with operation thereof.

On startup of the process, the solvent holding tank 38 is charged with a preferred processing solvent or aqueous solution by a conventional charging mechanism, such as the pumping arrangement as depicted in FIG. 1. The charging mechanism as shown includes connecting valves 52 and 54 and an activating pump 46. Opening valves 54 and 52 and activating pump 46 charges the solvent holding vessel 38 to a volume needed to charge the complete system. The air displaced from the holding tank passes through check valve 66, and a carbon filter 28 to prevent any air pollution discharge to the environment.

Upon filling the solvent holding tank 38, the heated solvent vessel 58 is evacuated by first sealing the cleaning chamber 12 by closing lid 88, closing valve 24, opening valves 76 and 30 and activating an air handling (vacuum) pump 26 to evacuate both the cleaning chamber 12 and heated solvent vessel 58. In the preferred embodiment, vacuum pump 26 is an oil sealed rotary vane, or rotary piston pump, capable of vacuum levels less than 1 torr. Other air handling pumps such as mechanical dry pumps, pneumatic pumps, diaphragm pumps or constant displacement, or other conventional vacuum pumps can also be used. If solvent is present in heated solvent vessel 58, air can be removed by using a solvent handling vacuum pump 36 by opening valves 76 and 50 and activating the pump 36. The air-solvent vapor mixture passes through a condenser 34, and enters solvent holding tank 38 where condensed solvent is collected. The discharged air passes through check valve 66 and activated carbon filter 28. In the preferred embodiment, vacuum pump 36 is a liquid ring pump sealed with the system processing solvent. Other pumps such as mechanical dry pumps, pneumatic pumps, diaphragm pumps or constant displacement, or other conventional vacuum pumps can also be used. The processing solvent is circulated and chilled by heat exchanger 51 by opening valve 92, and activating the circulation pump 16. The heat exchanger can be chilled by outside water, re-circulated water as from a cooling tower or by other conventional cooling methods such as using a refrigerated chiller or air-cooling.

Clean solvent can now be introduced to the heated solvent vessel 58 by activating circulation pump 16 and opening valve 72. Upon filling the heated solvent vessel 58, the solvent in the vessel 58 is heated to the desired operating temperature that is below the solvent's normal Boiling Point (NBP). In the preferred embodiment, an electric heater 40 is used. Also in the preferred embodiment, the cleaning chamber 12 is heated by activating the electric heater 14.

Upon heating the solvent and vessels, a part 20 to be treated can be placed in the decompression chamber 12 on an appropriate holder 22. Closing lid 88 and vent valve 24 then seals the chamber 12. Vacuum pump 26 is then activated, valve 30 is opened, and the chamber 12 is evacuated of essentially all the air. Typically, oil sealed pumps can evacuate the chamber to pressures of less than 10 torr and in the preferred embodiment, vacuum levels of 1 torr or less are desired. Upon evacuating to 1 torr, pump 26 is turned off and valve 30 is closed.

To initiate processing, valves 76 is opened and since the vessels are free of air, the solvent in the heated solvent vessel 58 flashes into the processing chamber 12 and increases the pressure to near the vapor pressure of the solvent or solution in vessel 58. Upon opening valves 74 and 18 and flashing vapor, the solvent in the heated vessel 58 cools. Electric heater 40 continuously heats the solvent. As indicated above, the solvent in the heated vessel 58 is heated to a temperature below the solvent's normal boiling point (NBP). If the temperature of the vessels 12 and 58 is below the normal boiling point, both vessels will be under negative gauge pressure, the pressure being approximately equal to the vapor pressure of the processing solvent at the operating temperature chosen. The cleaning chamber can operate at temperatures above the NBP of the solvent provided lid 88 is locked in position by locking rings, clamps, or other conventional means (not shown) to provide for adequate sealing. Unlike open top vapor cleaners, the enclosed processing system 10 can thus be operated at any desired temperature depending upon the capacity of the electric heaters 14 and 40. Either monitoring the solvent temperature with a temperature-measuring device 84 and/or solvent pressure with a pressure-measuring device 86 can control the on/off cycling of the heaters.

In the basic preferred embodiment, heated liquid solvent can be introduced into the processing chamber through valve 74 by opening valve 44, closing valve 18 and activating pump 68. Upon filling the chamber 12 to a level that will submerge the part 20, pump 68 is turned off and valves 44 and 74 are closed. In this regard, a level switch 32 is installed within the chamber to automatically detect proper filling level, and turn off pump 68, and close valves 44 and 74. Thereafter, vacuum pump 36 is turned on, valve 50 is opened and vapor is removed from the chamber. Removal of the vapor reduces pressure within the system 10, and since the solvent in the chamber 12 is under vacuum, solvent bubbles will begin to nucleate at the solid surfaces including the surface of the part 20. If the vacuum pump 36 continues to evacuate vapors, the vapor bubbles at the surface will grow, detach from the solid surface and rise to the top of the vessel 12 to replenish the vapor being removed by the vacuum pump 36, thus maintaining the chamber at or around the vapor pressure of the solvent. Such a condition will continually allow replenishment of the surface with fresh solvent at the region where vapor bubbles are detached, i.e. the bubbles create a desired solvent flow over the surface of the part 20. These regions will thus experience a rapid increase in mass and heat transfer to and from this surface area. These regions will also experience rapid increases in the concentration of nonvolatile components in solution if such components are present. The decompression process thus enhances the treatment of the surfaces at these regions.

On the other hand, if valve 50 is closed after pulling a vacuum, the chamber 12 will rapidly return to the original pressure of the chamber 12 and the bubbles at the part surfaces will collapse releasing a large quantity of energy locally at these implosion areas. The release of energy can be used to remove contaminants at the surface as an example. If valve 50 is rapidly cycled on and off, a large quantity of energy can be delivered to a local region for surface processing.

Upon completion of processing object 20, valves 74 and 44 are closed to isolate the decompression chamber 12. Solvent is drained from the processing chamber 12 by opening valves 64 and 18 and activating pump 68. Upon draining chamber 12, valves 64 and 18 are closed and pump 68 is deactivated.

Solvent vapors are now withdrawn from chamber 12 by activating vacuum pump 36 and opening valve 50. The vapors withdrawn are condensed by three mechanisms. The solvent vapors first pass through condenser 34 where most of the vapors exit as liquid. The vapors are next compressed in vacuum pump 36, which condenses additional vapor. In addition, if the pump 36 is a liquid ring pump, during passage through vacuum pump 36, the vapor-liquid mixture is mixed with chilled solvent, which is circulated to the vacuum pump by circulation pump 16. The solvent is chilled by heat exchanger 51 when valve 92 is opened. The condensed vapors and chilled solvent are returned to holding tank 38 and since all the fluids pumped to the vessel are condensable, the holding tank 38 remains at atmospheric pressure and no solvent vapor is discharged to the environment.

The solvent ring pump 36 preferred on the basic unit 10, if sealed with the processing solvent, is limited to a vacuum pressure which can be attained in chamber 12, depending upon the vapor pressure of the chilled solvent sealing the pump and/or the number of stages of the vacuum pump. In the preferred embodiment, vacuum levels in chamber 12 typically can reach 100 torr or less with a single stage vacuum pump and can reach 10 torr with higher boiling solvents and/or highly chilled solvent with a dual stage vacuum pump 36. At these vacuum pressures any solvent liquid remaining on the processed object 20, on the holder 22, or in the chamber 12 will generally flash into the vapor state and will also be removed from the chamber 12. There generally will remain some residual vapors, which are desirable to recover to prevent solvent emissions prior to opening chamber 12. If higher vacuum levels are required, dry pumps or diaphragm pumps can be used for increased solvent removal.

Upon removing solvent vapor from chamber 12, valve 50 is closed to again isolate the chamber 12, and valve 24 is opened to introduce ambient air to. the processing chamber 12. The concentration of processing solvent vapor within chamber 12 is now low enough so that essentially all of the air-vapor mixture can be removed utilizing the air-handling pump 26. Pump 26 is activated and the residual air-vapor mixture is removed from chamber 12 by opening valve 30. The mixture is pumped to carbon filter 28 through check valve 60 to the environment.

After evacuating chamber 12 of essentially all vapor and air, the chamber is again isolated by closing valve 30. The chamber is then returned to atmospheric pressure by opening valve 24.

If desired, chamber 12 can be evacuated a second time by closing valve 24, opening valve 30, and activating vacuum pump 26 a second time. Air being removed passes through carbon filter 28 prior to discharge to the atmosphere. After pump down, closing valve 30 again isolates chamber 12 and turning off pump 26 returns the chamber to atmospheric pressure when valve 24 is opened. Lid 88 is opened and the part 20 is removed and dried of all solvent.

The above process describes the basic vacuum cavitational streaming (VCS) process. There are a number of process problems that can occur in the basic VCS process described above. It is the object of this invention to provide an easier means and added flexibility to the process so as to make the process more universal for industrial use. The following examples outline the process improvements and illustrate the added advantage of each improvement.

Example of Working Systems

Increased Bubble Implosion Frequency System

Nucleate bubble studies have suggested that the vapor bubble generation at the solid surface is generally on the order of 50 to 200 Hz. Because of the practical limitation of the size of the vacuum pump required to evacuate the processing chamber after the implosion of vapor bubbles with non-condensable gases, practical implosion frequencies are generally less than 1 Hz for the VCS process described above meaning that more than 98% of the bubbles generated actually detach from the objects surface.

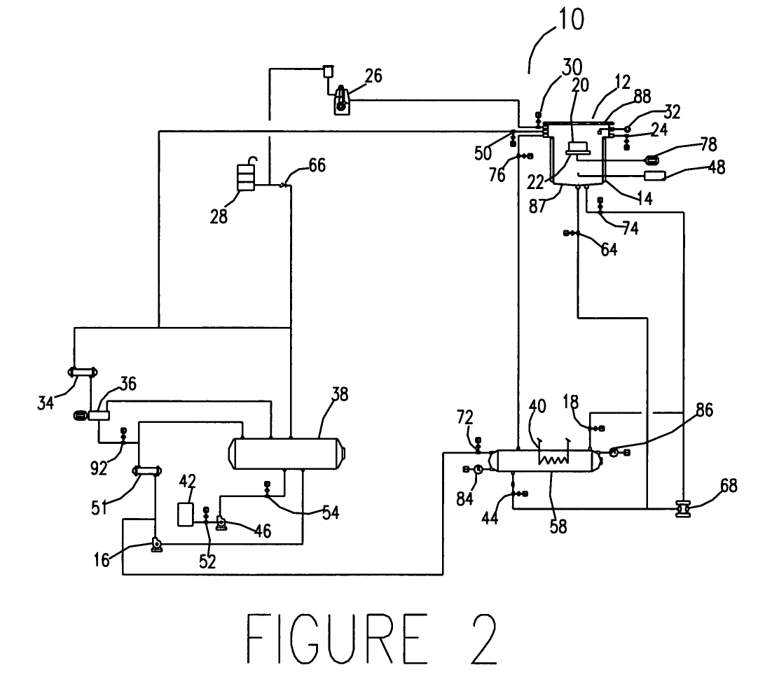

A simpler, much faster means can be used to produce vapor bubbles at the solid surface. As depicted in FIG. 2, object 20 can be placed on a holder 22 that can be rotated by activating motor 78. Rotating the object 20 being treated produces a fast moving liquid region near the solid surface. This results in a local pressure drop within this fluid near the surface. Any reduction in pressure within a fluid volume within this chamber 12 will result in the instantaneous formation of vapor bubbles since the fluid prior to motion is at the systems vapor pressure. The lowest pressure would occur at the solid surface since this is the fluid attaining the highest velocity in the system. The bubbles can either be continuously generated by continuing the rotation or can be collapsed as above to release energy. Collapsing of the bubbles can be accomplished by simply stopping the objects rotation or by increasing the total pressure in the system by adding a non-condensable gas to the chamber. As indicated, imploding bubbles would occur at the solid surface since this is the region of lowest pressure and therefore the implosions would effectively target the solid surface. Growing bubbles in this manner would produce vapor at the solid surface that would more easily diffuse material to the solid surface for treating the surface. Imploding the bubbles would release energy at the surface for either removal or increased transfer of material from the solid surface.

The above method of bubble generation has three major advantages. The process is much simpler than opening and closing valves to evacuate and inject gases and vapors to and from the chamber. The amount of vapor generated would be less since bubbles would not be generated on non-rotating surfaces such as the vessel walls and within the bulk fluid. Electrical switching such as oscillating a motor can be much faster than mechanical switching such as the opening and closing of a valve thus can operate at a higher frequency.

Controlled Mass Transfer System

As a working example, an ammonia surface treatment process will be outlined. In the preferred embodiment, an aqueous ammonia solution is used as a processing fluid. Ammonia is a well-accepted surface passivation compound. In a preferred process, a 0.8% ammonia solution is heated in an air free heated solvent vessel 58 to 120 degrees Fahrenheit at which the pressure of the vessel will rise approximately to 200 torr, the vapor pressure of the solution at this temperature. After a part or article 20 is placed in the processing chamber 12 on an appropriate holder 22 and lid 88 is sealed, valve 24 is closed to isolate the chamber. Pump 26 is activated to evacuate the chamber 12 through open valve 30 and through carbon filter 28.

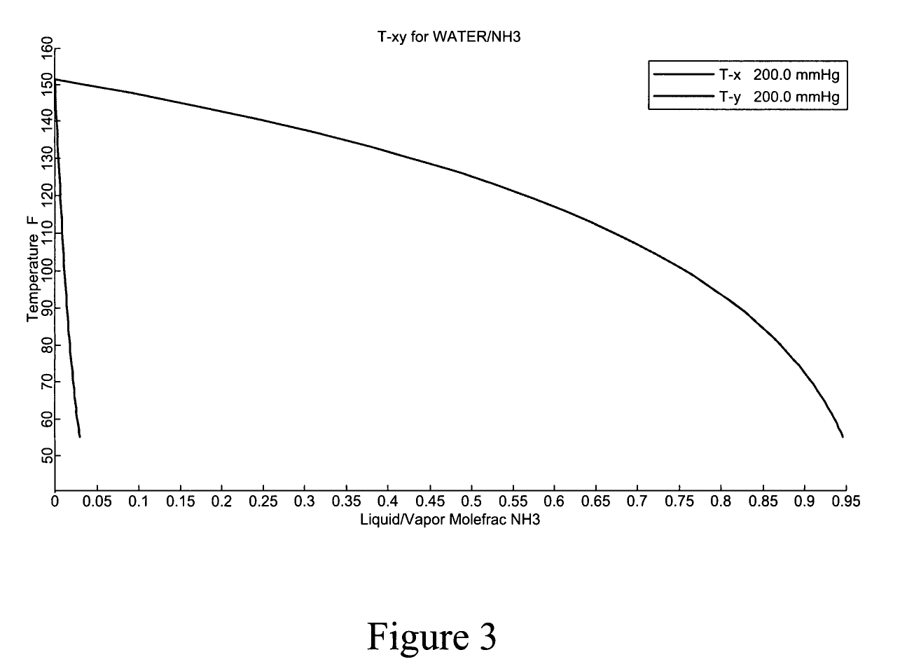

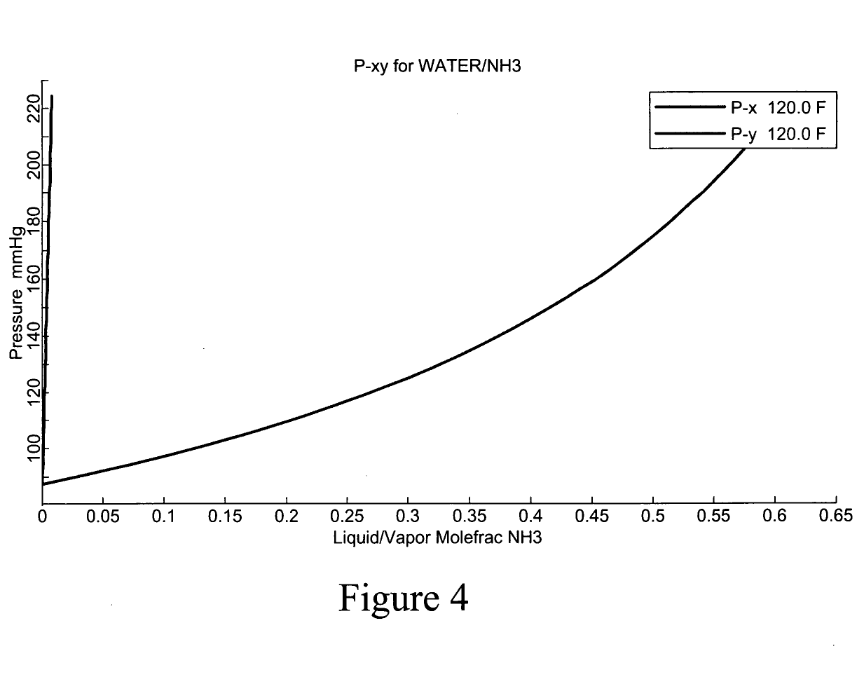

After evacuating chamber 12 to a vacuum level of 1 torr or less, valve 30 is closed to isolate the chamber 12, and valves 74 and 18 are opened to introduce hot ammonia-water vapors to the chamber 12. Condensed vapors and contaminate removed from the part 20 is returned to the heated solvent tank 58 by opening valves 64 and 18 and turning on pump 68. Simultaneously, heat is introduced to the system 10 through electric heater 40 and electric heat jacket 14, respectively, heating both the solvent vessel 58 and cleaning chamber 12 walls up to 120 degrees Fahrenheit. Vapor condensing continues until part 20 reaches temperatures in excess of 115 degrees Fahrenheit at which point valve 18 is closed and valves 74 and 44 are opened to introduce solution to the chamber. After submerging the part 20, valve 74 is closed and pump 68 is turned off. Vacuum pump 36 is then turned on, valve 50 is opened and vapor is removed from the chamber. Removal of the vapor reduces pressure within the system 10, and since the solution in the chamber 12 is under vacuum, solution bubbles will begin to nucleate at the solid surfaces including the surface of the part 20. If the vacuum pump 36 continues to evacuate vapors, the vapor bubbles at the surface will grow, detach from the solid surface and rise to the top of the vessel 12 to replenish the vapor being removed by the vacuum pump 36, thus maintaining the chamber at or around the vapor pressure of the solution. The bubbles formed at the surface contain a high concentration of ammonia. FIG. 3 shows an equilibrium curve for ammonia-water at a typical VCS pressure level. At 200 mmHG, the bubble point can be attained at room temperture at concentrations as low as 2 mole % ammonia. FIG. 4 shows the equilibrium curve at the temperature of 120° F. used in this example. At 120° F. and 200 mmHg, it can be seen in the Figure that the solution is at its' bubble point. Lowering the pressure to below 200 mmHg continues to produce bubbles nucleating at the object surface. As can be seen, for a 0.8 mole % ammonia liquid solution, a vapor concentration in excess of 50-mole % is produced in a boiling vapor phase. The ammonia in the vapor phase has a diffusion coefficient 100 fold greater than the ammonia in the liquid phase. In addition, increasing the concentration from 0.8 mole % in the liquid phase to greater than 50-mole % in the vapor phase increases the driving force for mass transfer by over 50 fold. The combination of the increased mass transfer coefficient and increased driving force should increase the mass transfer rate by greater than 5000 times the rate attained in the liquid phase.

Other aqueous solutions used to treat object surfaces that would be enhanced by the VCS process by transferring the reacting component into the vapor phase include solutions of hydrochloric, sulfuric, nitric, fluoric, or any other acids, sodium, potassium or any other hydroxide, and hydrogen or any other peroxide.

From the described system above, the rate of mass transfer and interaction of a chemical with the solid surface is controlled by the rate at which the bubble generation is controlled. If bubbles are not generated, the mass transfer rate can be expected to be low with little surface reaction. If the bubble generation were high, the surface treatment would be rapid. The process allows for a rapid means of “turning the surface reaction” on or off.

The above process has three major advantages to straight liquid treatment of surfaces. The solutions used can be much lower in concentration such as in an acid, thus limiting the reaction of the solution with support equipment, tanks and pipes. The process rate can be controlled easier and is not depended upon the total contact time of the fluid as opposed to the amount of VCS time the part is exposed to. The amount of waste generation would be lower since lower concentrations are required.

Waste Management System

The system described above does have one major flaw in the design. Since the vapor bubbles formed usually have a high concentration of highly reactive chemical, in the case above ammonia, the vacuum pump would be removing a large amount of potentially hazardous waste during the bubble generation process. If non-condensable gases are used to collapse the bubbles, the gas needs to exit the system at some time since an entering gas stream cannot continuously accumulate in the system. In order to expel this gas, if the vapor in the gas is hazardous, the gas stream would need to be treated prior to discharge to the environment.

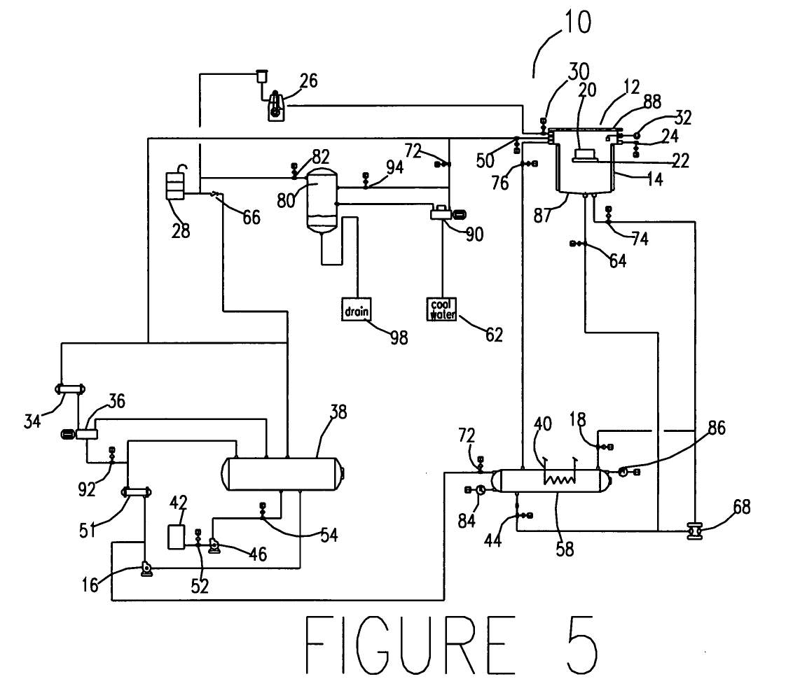

A simple means to strip the chemicals from the exiting waste stream would be to reverse the VCS process by compressing the exiting stream and adsorbing the vapors from the gas into a liquid stream prior to discharging the gas. FIG. 5 depicts a means by which this can be accomplished. In the preferred embodiment, the vacuum pump is the compressor and the pump is a liquid ring pump. If the pump is sealed with a liquid that can absorb the vapors, then the pump can serve a dual function of both compressing and absorbing the hazardous vapors. In this case in FIG. 5, an exiting stream of nitrogen and ammonia mixture is being removed from the VCS processing chamber 12 using liquid ring vacuum pump 90 through valve 82. The liquid ring pump is fed with cool water from source 62. As the gas-vapor mix enters the pump, the mixture is compressed in the vacuum pump and the sealant water can now adsorb the ammonia in the gas mixture. The exit stream is then sent to a separation vessel 80 where the liquid is allowed to drop out of the gas phase. The liquid can either be cooled and recycled to the vacuum pump 90 as sealant or sent to the drain 98 as shown in FIG. 5. The gas can be trapped in the upper portion of the separation tank, sent for further treatment as to a carbon filter 28 as shown, or recycled to the vacuum pump to be mixed with fresh water again as shown by opening valve 94 and closing valve 82. Since the process is enclosed, the vapors can be stripped of chemicals by this method so as not to pollute the surrounding environment.

Controlled Implosion Energy Systems

The system above could also be used to impart energy to the surface by imploding bubbles. Pressurizing the chamber, preferably with non-condensable gases, to implode the bubbles formed during the vacuuming process, performs the VCS process. Often however, the imploding bubbles impart too much energy to the solid surface especially in intricate systems such as semiconductor wafers. Additives of non-condensable gases can dampen the rate and degree of implosion of the VCS bubbles. A typical system additive could be dissolved carbon dioxide. The CO₂ can be added such in carbonizing of water or generated such as in fermentation processes.

When a solution such as the ammonia solution above is depressurized, a vapor-gas mixture of ammonia, water and CO₂ is produced and when these bubbles are pressurized, the non-condensing CO₂ would resist the total collapse of the bubble thereby minimizing the energy released. Non-condensable gases that could be added include nitrogen, helium, hydrogen, oxygen and any gas having a normal boiling point below room temperature.

Other aqueous solutions that can be used that would dampen the VCS process by generating a non-condensable gas component in the vapor phase include solutions of hydrochloric, sulfuric, nitric, fluoric, or any other acids, sodium, potassium or any other hydroxide, and hydrogen or any other peroxide. These systems could also be used to control the magnitude of imploding bubbles since these reactions produce non-condensable gases that are added to the growing vapor bubble during pressure reduction and rapid reaction. Upon pressurization of the chamber, the non-condensable gases would resist the total collapse of the bubble thereby minimizing the energy released. Typically the non-condensable gases formed would be hydrogen in the case of acid reactions or oxygen in the case of peroxides however any no-condensable gas could be formed to help dampen the imploding vapor bubble's energy release.

Enhanced Bubble Generation System

In some systems it may be desirable to perform the VCS process at lower temperatures than is practical from a pressure point of view. For example normal methyl pyrrolidone, (NMP) is an excellent paint stripper or photo resist remover for semiconductor manufacturing. At room temperature however, NMP would have to be reduced to a pressure of less than 1 torr in order to produce cavitation bubbles. With the addition of 10% methylene chloride, however, bubbles could be produced at 33 torr, a more practical pressure at which to operate the VCS process. The addition of a lower boiling component to a high boiler would enable the production of bubbles at lower temperatures. Mixtures that are non-ideal are often desirable since these mixtures often boil at temperatures below either components's boiling point, often at azeotropic concentrations.

Another way to enhance bubble formation is to add heat or energy to the system as opposed to lowering the boiling point by pressure reduction. If a considerable number of cavitational bubbles are allowed to detach from the surface of object 20 in FIG. 2, the surface will experience a decrease in temperature since heat is removed from the surface when solvent is flashed from the liquid to the vapor state. It is therefore desirable to provide a means to maintain the surface temperature by exposing the surface to an energy source 56 that could be a beam of light, laser microwave, ultrasound or radiation.

The surface temperature of the object 20 being treated could also be maintained with a force convection heating method as shown in FIG. 2. In the preferred embodiment, a continuous heated stream of processing liquid from a liquid source 48 is injected into the chamber 12 in or near the region of the object 20 being treated. An equal quantity of fluid can be overflowed to a process fluid chamber 58 through open overflow valve 76 as shown in FIG. 2. The net result would be to maintain a heated region of fluid around the object 20 so as to generate a hot spot to enhance the formation of vapor bubbles. The preferred fluid is a heated liquid stream of processing fluid however the stream could also be a heated vapor or heated gas also used to collapse bubbles.

It can therefore be seen that the present invention provides a unique closed solvent and aqueous vacuum cavitational processing system that is more effective at producing bubble formation and treatment of parts within the system.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A method of treating an object in a closed solvent processing system, said system including a vacuum chamber, said object being disposed in said vacuum chamber, said system further comprising a solvent supply system in communication with said vacuum chamber, said solvent including a chemical treating agent, said method comprising the steps of:
isolating said solvent supply system from said vacuum chamber;
reducing pressure within said vacuum chamber to create a vacuum condition within said vacuum chamber;
introducing solvent from said solvent supply system into said vacuum chamber;
creating a vacuum within said vacuum chamber to cause a continuous stream of vapor bubbles to form at a surface of said object, said vapor bubbles having an increased concentration of vaporized chemical agent, said vapor bubbles treating said object by transferring said chemical agent to the surface of said object while said chemical agent is in a vapor state;
supplying energy to said vacuum chamber during vapor bubble formation to maintain said object at a substantially constant temperature;
recovering the solvent within the vacuum chamber;
recovering the solvent from the vacuum chamber exiting stream
isolating the vacuum chamber from the solvent supply system; and
introducing a gas into the vacuum chamber to sweep solvent from said object and from within the vacuum chamber.

2. The method of claim 1 wherein said step of supplying energy into said vacuum chamber comprises rapidly moving said object being treated so as to produce a low pressure region near the surface of said object to facilitate the formation of vapor bubbles.

3. The method of claim 1 wherein said step of supplying energy into said vacuum chamber comprises directing a heated fluid stream into the vacuum chamber near to the object being treated.

4. The method of claim 1 wherein said step of supplying energy into said vacuum chamber comprises directing a beam of energy at the surface of the object, wherein the object absorbs energy in order to prevent cooling of the surface.

5. The method of claim 4 wherein said beam of energy is selected from the group comprising: light, laser, microwave, ultrasound, radiation and combinations thereof.

6. The method of claim 1 wherein said step of supplying energy into said vacuum chamber comprises introducing pressure into said vacuum chamber to collapse said vapor bubbles so as to impart energy to the surface so as to reheat said surface.

7. The method of claim 1 wherein said solvent comprises a mixture having a component added to reduce the bubble point for ease of bubble formation within said chamber.

8. The method of claim 1 wherein said solvent includes a dissolved non-condensable gas for ease of bubble formation and to dampen the energy for imploding bubble systems within said chamber.

9. The method of claim 1 wherein the step of recovering the solvent from the vacuum chamber exiting stream includes sending the gas-vapor exiting mixture to a liquid ring pump where the stream is compressed and the vapors are absorbed into the pump sealing liquid.

10. The method of claim 9 wherein the liquid ring vacuum pumps discharge is sent to a liquid-gas separation tank where separated gases are recycled to the vacuum pumps inlet to be further stripped of solvent vapors.
